(19) United States
(12) Patent Application Publication
(10) Pub. No.: US 2002/0032789 A1
(43) Pub. Date: Mar. 14, 2002

(54) System and method for inter-network communications

(76) Inventors: Frank Bahren, Karlsruhe (DE); Joachim Wietzke, Karlsruhe (DE); Harald Schopp, Ettlingen (DE); Joachim Bischoff, Keltern (DE); Dirk Lappe, Karlsruhe (DE)

Correspondence Address: Samuels, Gauthier & Stevens LLP, 225 Franklin Street, Suite 3300, Boston, MA, 02110, US

(21) Appl. No.: 09/892,706

(22) Filed: Jun. 27, 2001

(30) Foreign Application Priority Data
Jun. 28, 2000 (DE) 100 30 525.3-31

(51) Int. Cl. G06F 15/16

(52) U.S. Cl. 709/230; 709/200

(57) ABSTRACT

A network that provides a simple mechanism for communicating between the network, such as a MOST network installed in a motor vehicle, and a second network, such as the Internet. One unit of the network includes a network layer of the second network as well as an associated application interface (API). The network layer is an Internet Protocol (IP) or Transmission Control Protocol (TCP) network layer. Also installed in the network unit is an associated application program interface. Together, the network layer and API enable the network units in first network to communicate with the second network. Proxy computers are installed in the remaining units to substantially reduce technical complexity without impairing communication with the second network.

### BACKGROUND OF THE INVENTION

The present invention relates generally to networks and, more particularly, to communicating between multiple networks.

The implementation of a local network in a motor vehicle is well known. One conventional approach to a local network in a vehicle is disclosed in German Patent Specification DE 195 03 213 C1. Such motor vehicles can include, for example, passenger cars, trucks, buses and other types of vehicles.

Commonly, the implemented network is the commercially-available Media Oriented System Transport or Media Oriented Synchronous Transfer (MOST). Such MOST networks are generally implemented to facilitate communications between equipment of a multimedia system. The multimedia equipment includes data sources such as, for example, a car radio, CD player, video recorder, TV tuner, etc., as well as data sinks such as, for example, an audio amplifier to which several loudspeakers are connected, or a display screen which displays an uncompressed video signal. For example, a MOST network in a motor vehicle can communicably couple a radio, television receiver, monitor, CD player, DVD or CD changer, cassette recorder, active loudspeakers, navigation system, car telephone, wireless telephone, as well as operating and control units, to cite only a few examples of these units.

It is also known that the network layers of a second network can be installed in each personal computer of a network. Network layers include, for example, the Transmission Control Protocol (TCP) and the Internet Protocol (IP). Due to its high technical complexity, a second network such as the Internet is not suited for installation in a motor vehicle, because only limited space and power are available in a motor vehicle.

Therefore, is a system and method for communicating between a first and a second network such that the first network is suitable for installation in a motor vehicle.

### SUMMARY OF THE INVENTION

Briefly, according to an aspect of the present invention, a network includes a plurality of network units and a communication path communicably linking the plurality of network units with each another. A first network unit of the plurality of network units has installed therein a network layer of a second network in combination with an associated application program interface (API). Also, a proxy computer is installed in each of the plurality of network units other than the first network unit.

In another aspect of the invention, a network for providing the capability to communicate over the Internet is disclosed. The network includes a plurality of network units communicably linked by a communication path. The plurality of network units includes a first network unit capable of transmitting and receiving external communications and having installed therein a network layer of the Internet in combination with an associated application program interface. The plurality of network units also includes a plurality of network units each having installed therein a proxy computer.

In yet another aspect of the invention, a vehicle-hosted multimedia system for providing the capability to communicate over the Internet is disclosed. The system includes a plurality of network units and a communication path for communicably linking network units with each another. The network units include a telephone configured as a network unit capable of transmitting and receiving external communications and having installed therein a Transmission Control Protocol (TCP) or Internet Protocol (IP) network layer of the Internet in combination with an associated application program interface. The network units also include several remaining network units each having installed therein a proxy computer.

These and other objects, features and advantages of the present invention will become more apparent in light of the following detailed description of preferred embodiments thereof, as illustrated in the accompanying drawings.

### BRIEF DESCRIPTION OF THE DRAWINGS

FIG. 1 is a block diagram of a local network suitable for implementation in a motor vehicle including one network unit thereof configured to communicate with a second network.

### DETAILED DESCRIPTION OF THE INVENTION

The present invention is directed to a network that includes a plurality of network units and a communication path communicably linking the plurality of network units with each another. A first network unit of the plurality of network units has installed therein a network layer of a second network in combination with an associated application program interface. Also, a proxy computer is installed in each of the plurality of network units other than the first network unit.

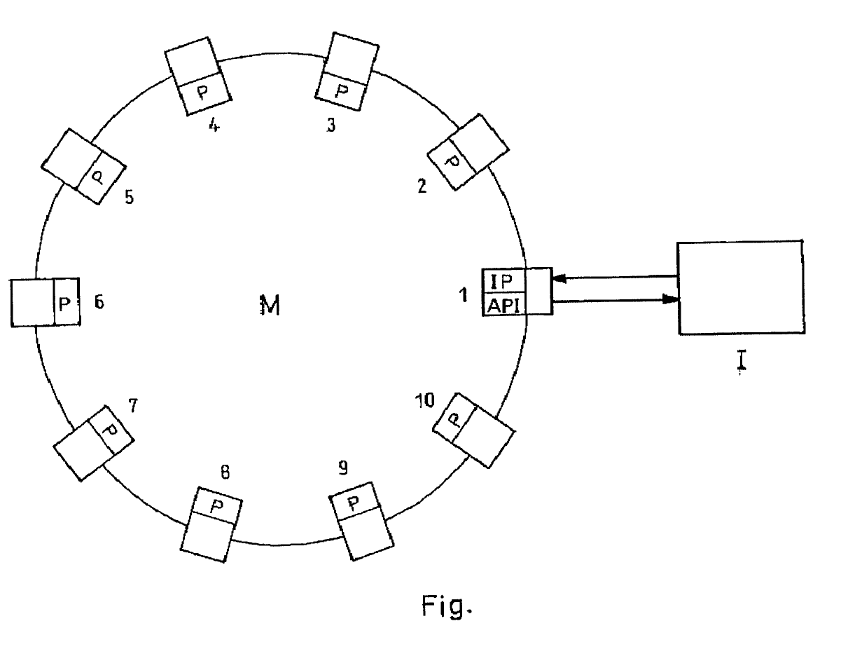

FIG. 1 is a schematic diagram of one embodiment of the network of the present invention. In this illustrative embodiment, a network 100 includes several units 101 to 110 communicably coupled by a communication path 111. In accordance with an aspect of the present invention, one particular network unit 101 has installed therein at least one network layer 113 of a second network 112. In one embodiment of the invention, the first network 100 is a Media Oriented System Transport (MOST) network implemented in, for example, a motor vehicle, and the second network 112 is the Internet, although the present invention can be used in conjunction with any other network.

In the illustrative embodiment, the network layer 113 is an Internet Protocol (IP) network layer, although in other embodiments other network layers of the second network 112 can be installed in unit 101. For example, in an alternative embodiment, the network layer 113 is a Transmission Control Protocol network layer. Also installed in the network unit 101 is an associated application program interface (API). Together, the network layer 113 and API 114 enable network units 101-110 in first network 100 to communicate with the second network 112. Preferably, network unit 101 is a telephone in which are installed the network layers 113 of the Internet 112 and the API 114. A telephone is best suited for this function because it represents a transmission and reception unit for external communication.

A well-known proxy computer 115 is installed in the remaining units 102-110 of first network 100. It is advantageous to install the proxy computers 115 in the form of software in the hardware platform provided by the units 102-110 because such an approach requires no additional hardware complication. The inventive measure of installing the network layer(s) 113 of the second network 112 and an API 114 only in one of the units 101 of the first network 100, while installing the technically uncomplicated proxy computers 115 in the remaining units 102-110, substantially reduces technical complexity without thereby impairing communication with the second network 112.

While various embodiments of the present invention have been described above, it should be understood that they have been presented by way of example only, and not limitation. For example, it should be understood that the present invention is not limited to application in an MOST network, but can be implemented in any network. The inventive method and the inventive network are especially well suited for use in a motor vehicle.

Although the present invention has been shown and described with respect to several preferred embodiments thereof, various changes, omissions and additions to the form and detail thereof, may be made therein, without departing from the spirit and scope of the invention.

What is claimed is: List of Reference Symbols API API IP Internet protocol I Internet M MOST network P Proxy computer 1 Telephone 2-10 Unit

1. A method for communicating between a first network (M), which links several units (1 to 10) with one another, and a second network (I), characterized in that the network layers (IP) of the second network (I) as well as an associated application interface (API)—a so-called API—are centrally implemented in one of the units (1) of the first network (M) for the remaining units (2 to 10), while so-called proxy computers (P) are installed in the remaining units (2 to 10).

2. A network (M), which links several units (1 to 10) with one another, characterized in that the network layers (IP) of a second network (I) as well as an associated application interface (API), a so-called API, are centrally present in one of the units (1) for the remaining units (2 to 10), while a so-called proxy computer (P) is present for each of the remaining units (2 to 10).

3. The method or network of claim 1 or 2, characterized in that the first network is an MOST network and the second network is the Internet (I).

4. The method or network of claim 1, 2, or 3, characterized in that the unit (I) with the network layers (IP) of the second network (I) and the API (API) is a telephone.

5. The method or the network of one of the preceding claims, characterized in that the proxy computers (P) are installed in the form of software.

6. (New) A network comprising:
a plurality of network units;
a communication path communicably linking the plurality of network units with each another; and
wherein a first network unit of the plurality of network units has installed therein a network layer of a second network in combination with an associated application program interface, and further wherein a proxy computer is installed in each of the plurality of network units other than said first network unit.

7. (New) The network of claim 6, wherein said first network is configured as a Media Oriented System Transport (MOST) network.

8. (New) The network of claim 6, wherein said second network is the Internet.

9. (New) The network of claim 6, wherein said network layer comprises a Transmission Control Protocol (TCP) network layer.

10. (New) The network of claim 6, wherein said network layer implements Internet Protocol (IP) network layer.

11. (New) The network of claim 6, wherein said second network is the Internet.

12. (New) The network of claim 6, wherein said first network is capable of transmitting and receiving external communications.

13. (New) The network of claim 12, wherein said first network unit comprises a telephone.

14. (New) The network of claim 6, wherein a plurality of said remaining network units each comprise a computer platform wherein a proxy computer is installed in the form of one or more software programs.

15. (New) The network of claim 6, wherein the network units comprise equipment of a multimedia system.

16. (New) The network of claim 15, wherein said plurality of network comprise one or more data sinks and one or more data sources.

17. (New) The network of claim 15, wherein said one or more data sinks comprise one or more of the group including a car radio, a CD player, a video recorder, a TV tuner, an audio amplifier, and a display screen.

18. (New) A network for providing the capability to communicate over the Internet, comprising:
a plurality of network units including,
a first network unit capable of transmitting and receiving external communications and having installed therein a network layer of the Internet in combination with an associated application program interface;
a plurality of remaining network units each having installed therein a proxy computer; and
a communication path for communicably linking said network units with each another.

19. (New) The network of claim 18, wherein said first network is configured as a Media Oriented System Transport (MOST) network.

20. (New) The network of claim 18, wherein said network layer comprises a Transmission Control Protocol (TCP) network layer.

21. (New) The network of claim 18, wherein said network layer implements a Internet Protocol (IP) network layer.

22. (New) The network of claim 18, wherein said first network unit comprises a telephone.

23. (New) The network of claim 18, wherein said network units comprise equipment of a multimedia system.

24. (New) The network of claim 23, wherein said plurality of network units other than said remaining network units comprise one or more data sinks and one or more data sources.

25. (New) A vehicle-hosted multimedia system for providing the capability to communicate over the Internet, comprising:
a plurality of network units including,
a telephone configured as a network unit capable of transmitting and receiving external communications and having installed therein a Transmission Control Protocol (TCP) or Internet Protocol (IP) network layer of the Internet in combination with an associated application program interface;
a plurality of remaining network units each having installed therein a proxy computer; and
a communication path for communicably linking network units with each another.
